(19) United States
(12) Patent Application Publication
(10) Pub. No.: US 2020/0143111 A1
(43) Pub. Date: May 7, 2020

(54) System and Method for Generating a Display from Multiple Media Formats

(71) Applicants: Jon Frank Shaffer, Main Beach (AU); Gary Smith, Main Beach (AU)

(72) Inventors: Jon Frank Shaffer, Main Beach (AU); Gary Smith, Main Beach (AU)

(21) Appl. No.: 16/609,391

(22) PCT Filed: May 4, 2018
(86) PCT No.: PCT/US2018/031259

§ 371 Date: Oct. 29, 2019

Related U.S. Application Data
(60) Provisional application No. 62/501,752, filed on May 5, 2017.

(51) Int. Cl. G06F 40/186; G06F 16/958; G06F 16/93; G06F 40/117

(52) U.S. Cl. CPC G06F 40/186; G06F 40/117; G06F 16/93; G06F 16/986

(57) ABSTRACT

A system and method for generating a display on a client device where a display template is created with embedded tags to identify media format types to permit the combination of different types of media on a single display. The system and method may incorporate artificial intelligence to personalize the display to the needs of the user.

### FIELD OF THE INVENTION

Various embodiments of a method and a system for generating a display and electronic documents incorporating the display are described herein.

### SUMMARY OF THE INVENTION

According to an aspect, there is provided a method of generating a visual display on a client device, the method comprising the steps of: receiving client information from the client device; transmitting a content template to the client device;

executing information retrieval software in the client device so that the client device finds and retrieves media relating to the client information; and

displaying a mashup on the client device using the retrieved media and according to the content template.

The steps of receiving the information from the client device and transmitting the content template may be carried out over a wireless network.

The step of executing the information retrieval software in the client device may be carried out so that the retrieved media includes media retrieved from the client device.

The step of executing the information retrieval software in the client device may be carried out so that the retrieved media includes media retrieved from various sources on the Internet. The retrieved media may also include media retrieved from a provider device or server.

The method may include the step of displaying the mashup on the client device together with provider information relating to the client information.

The information retrieval software may be transmitted from the provider device or server to the client device.

According to an aspect, there is provided a system for generating a visual display on a client device, the system comprising:

the client device that stores information retrieval software and that is configured to execute the information retrieval software upon receipt of information from a provider device or server; and

the client device that is configured to receive a content template from the provider device and to display a mashup using media retrieved as a result of the execution of the information retrieval software.

According to an aspect, there is provided a method of generating an electronic document, the method comprising the steps of:

receiving, in a server, a transaction request from a client device; receiving, in the server, transaction confirmation data from a provider device or server;

generating, in the server, an electronic document that displays details of the transaction request and the transaction confirmation for rendering on the client device;

transmitting the electronic document to the client device together with a content template; and

embedding the content into the electronic document in the client device according to the content template.

The step of generating the content may include the step of executing information retrieval software in the client device to retrieve content related to at least one of the client and the provider and creating a mashup with the retrieved content.

The content may be retrieved from at least one of the client device, websites, and the provider device or server.

The method may include the step of executing information retrieval software in the client device to search for, and identify, content related to the client.

The method may include the step of receiving a content template from the provider device and embedding the content into the electronic document according to the content template.

According to an aspect, there is provided a system for generating an electronic document, the system comprising:

a server that is configured to:

receive a transaction request from a client device and transaction confirmation data from a provider device or server;

generate an electronic document that displays details of the transaction request and the transaction confirmation for rendering on the client device; and

transmit the electronic document to the client device together with a content template.

According to a further aspect, there is provided a platform for combining multiple media channels and/or content types for display on a single display of, for example, a client device. The media channels and/or content types may include one or more of a URL, static image, text, video, audio, and scannable images such as barcodes. The platform may be configured to incorporate augmented reality to enhance presentation. A template may be configured with two or more tags, each tag being configured for a specific media channel or content type. The tags may be embedded in the template. A resident orchestration module may be embedded in the template and configured with one or more algorithms to search and retrieve media based on any one or more of user traits, patterns, and other factors such as user location and any time parameters. Images or video may be overlaid other media within the display. In an example, a dynamic video receipt may be generated.

### BRIEF DESCRIPTION OF THE DRAWINGS

FIG. 1 shows a system for generating a visual display on a client device and electronic documents.

FIG. 2 is a functional block diagram illustrating one embodiment of a method for generating a visual display on a client device.

FIG. 3 is a diagram indicating functions of various components of the system of FIG. 1.

FIG. 4 is a flow diagram illustrating one embodiment of a method for generating electronic documents using the system of FIG. 1.

FIG. 5 is an example of a visual display generated using the system of FIG. 1.

FIG. 6 is an example of an electronic document generated using the system of FIG. 1.

FIG. 7 is an example of an electronic document generated using the system of FIG. 1.

FIG. 8 is an example of an electronic document generated using the system of FIG. 1.

FIGS. 9 to 15 show a sequence in the compilation of the electronic document of FIG. 8 using the system of FIG. 1.

FIG. 16a shows a system for generating a visual display on a client device and electronic documents, the system including a centralized back-end orchestration module.

FIG. 16b shows a system for generating a visual display on a client device and electronic documents, the system including a distributed orchestration module.

### DETAILED DESCRIPTION

The systems and the methods described herein can be implemented using a server-based virtual facility. Details of an exemplary implementation of the system are provided in international patent application publication number WO 2011/041827A1, and U.S. Provisional Application No. 61/746,774 by J. Frank Shaffer, the entire contents of these applications being incorporated herein by reference. It is envisaged that various other implementations can also be used.

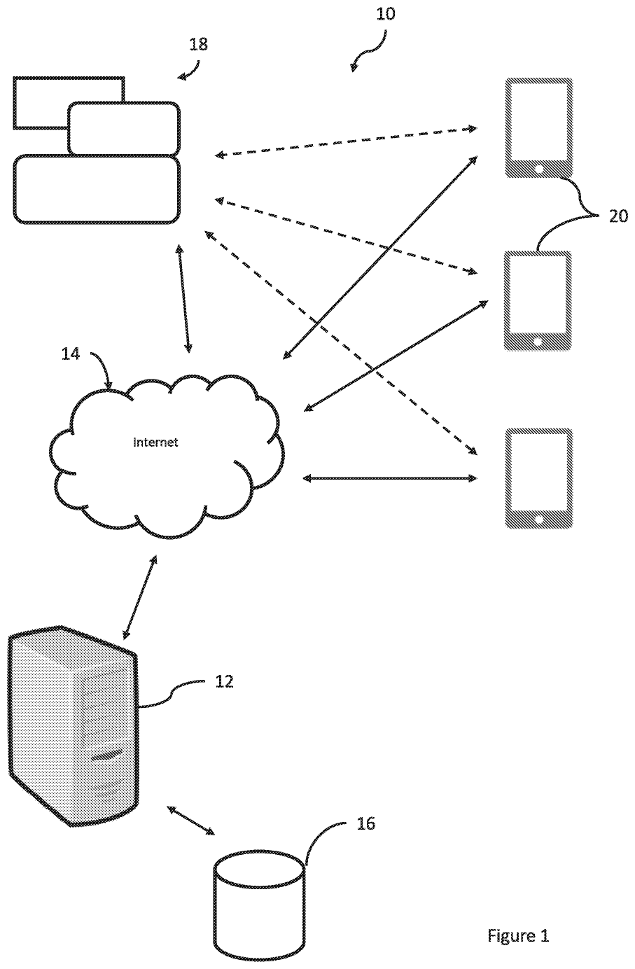

In FIG. 1, reference numeral 10 generally indicates a system for generating mashups and electronic documents. A “mashup” is typically understood as a combination of media content, often (though not always) from different sources. The mashups can be used for a variety of purposes. For example, the mashups can be combined with the electronic documents. The electronic documents can be configured to reflect or confirm a transaction between a client and a provider.

In this specification, the term “electronic document” encompasses a web page and an interactive display on a touchscreen of a mobile device, for example, when executing an app stored on the mobile device. The “electronic document” need not be two-dimensional. For example, it can be in the form of a three-dimensional display, for example, a virtual reality display. Furthermore, the term “electronic document” also encompasses a visual display that can incorporate video, still images and text.

In this specification, the word “transaction” refers to any interaction between two parties where it is desirable or mandatory that the interaction be recorded. The transaction need not be a commercial transaction. For example, the transaction could be an agreement between two parties to meet up. In that case, the client would generate the request to meet up, which the provider would accept. The ensuing electronic document would reflect that agreement and contain details regarding the meet up.

Also in this specification, the word “client”, in addition to its generally understood meaning in the context of networks and information technology, is used to refer to any entity that transacts with another entity, the “provider”, where a record of the transaction is required. For example, the client can be an entity that acquires agreement, services or merchandise from a provider. The services or merchandise can take many forms, such as tickets for events, boarding passes or tickets for transport, goods, and other forms. The services or merchandise are not necessarily acquired for value. The provider is then an entity that provides agreement, services or merchandise to the client. In various embodiments, the provider might be a seller and the client might be a customer or client.

The system 10 includes a provider device that can be in the form of a content server 12. The content server 12 can communicate with various electronic devices via a communications network, such as a wireless network, for example, the Internet, indicated at 14. Other examples include private networks that could be local area networks or wide area networks. The content server 12 can be defined by one or more data processing apparatus or computers, either operating singly or as part of a distributed communications network. The content server 12 could be provided by one or more mobile devices. The content server 12 could be a virtual server.

The content server 12 is operatively connected to a content database 16. The database 16 is configured for storing content associated with clients and providers. The content can take various forms. The content can include text files, video files, for example GIFs, images, sound files and other forms of content that can be associated with clients. In one embodiment, the content database 16 can be a relational database so that content components can be associated with respective clients. It is envisaged that any form of database structure that is suitable for storing data components in relation to each other might be suitable. The content server 12 is configured to read data components from the content database 16 so that data components associated with client details can be selected and transmitted wirelessly over the Internet 14.

The content database 16 is also configured for storing content templates that are transmitted to the content server 12 by providers. The content templates can include content placeholders so that selected content can be placed in the templates. The content templates can be configured to include content placeholders so that the content selected for those placeholders can be retrieved from various sources, including the client devices, social network platforms and the Internet. The content can also be retrieved from, or supplied by, the provider.

The system 10 includes a point of sale (POS) apparatus 18. The POS apparatus 18 can incorporate various devices and is not limited to an apparatus found in a bricks and mortar establishment such as a teller machine and associated equipment. For example, the POS apparatus 18 can incorporate a provider intranet containing various devices that would usually be found in an intranet of a provider, such as a commercial merchant. Thus, the apparatus 18 can include computers, servers, tellers, scanners, mobile devices and other apparatus that would usually be used by a merchant, either in the form of a bricks and mortar merchant or an online merchant. It will readily be appreciated that the apparatus 18 can also be a server maintained by the provider in an online environment. In such a case, the server can take forms similar to the content server 12.

The apparatus 18 is also connected to the Internet 14 so that it can communicate with the content server 12.

Various electronic devices 20 associated with respective clients can be wirelessly connected to the content server 12 via the Internet 14. Also, the electronic devices 20 can be connected to the apparatus 18 via the Internet 14. It is envisaged that the electronic devices 20 can be wirelessly connected to the content server 12 and the apparatus 18 in other ways, for example, via a wireless private network in the form of a local area network or a wide area network. It is also envisaged that the electronic devices 20 can be wired to the content server 12 and the apparatus 18 in various applications.

The electronic devices 20 can be mobile devices, such as mobile phones and/or tablets. Such devices may have touchscreens. Thus, clients can interact with the electronic documents using the touchscreen.

The electronic devices 20 are configured to execute search and retrieval software. The search and retrieval software can be transmitted to the electronic devices 20 from the apparatus 18.

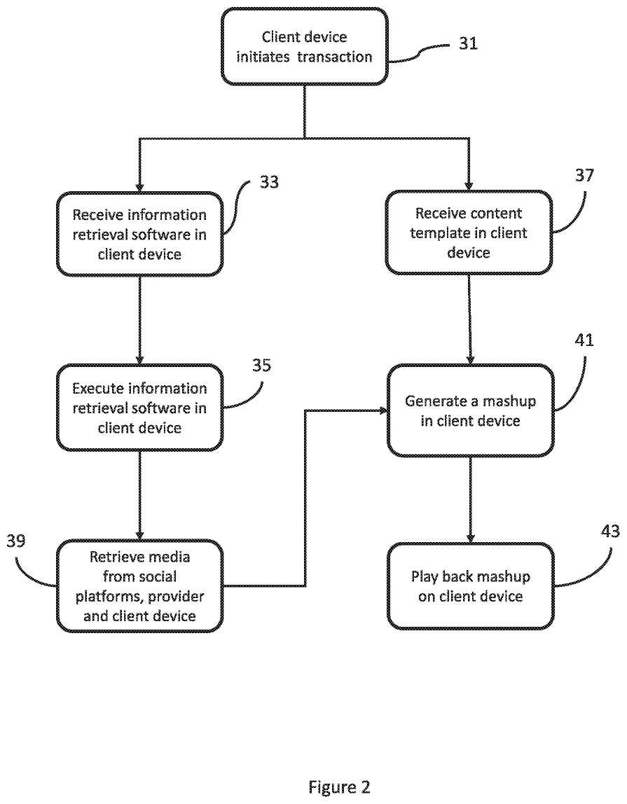

FIG. 2 is a flow diagram indicating a method of using the system 10 to generate a mashup.

At 31, the client device initiates a transaction. At 33, the client device 20 receives information retrieval software from a provider. The client device 20 also receives a content template from the provider.

At 35, the client device executes the information retrieval software. The information retrieval software can be in the form of software to carry out information search and retrieval operations on databases and repositories of information.

These databases and repositories of information can include the client device 20, the apparatus 18, the Internet and various other repositories. For example, at 39, the client device 20 retrieves information or media from sources such as social platforms, the apparatus 18 and information or media stored on the client device. Such software can search for and retrieve media from those sources, the media being related to a user of the client device according to various parameters, such as purchase history, browsing history, the subject of the transaction, the identification of the provider, and various other parameters that would be used by such search and retrieval software.

At 37, the client device 20 receives a content template from the apparatus 18. The content template includes placeholders for the retrieved media. At 41, the client device 20 generates a mashup using the retrieved media and the content template. The mashup is displayed on the client device 20 at 43. An example of the use of the mashup is described below.

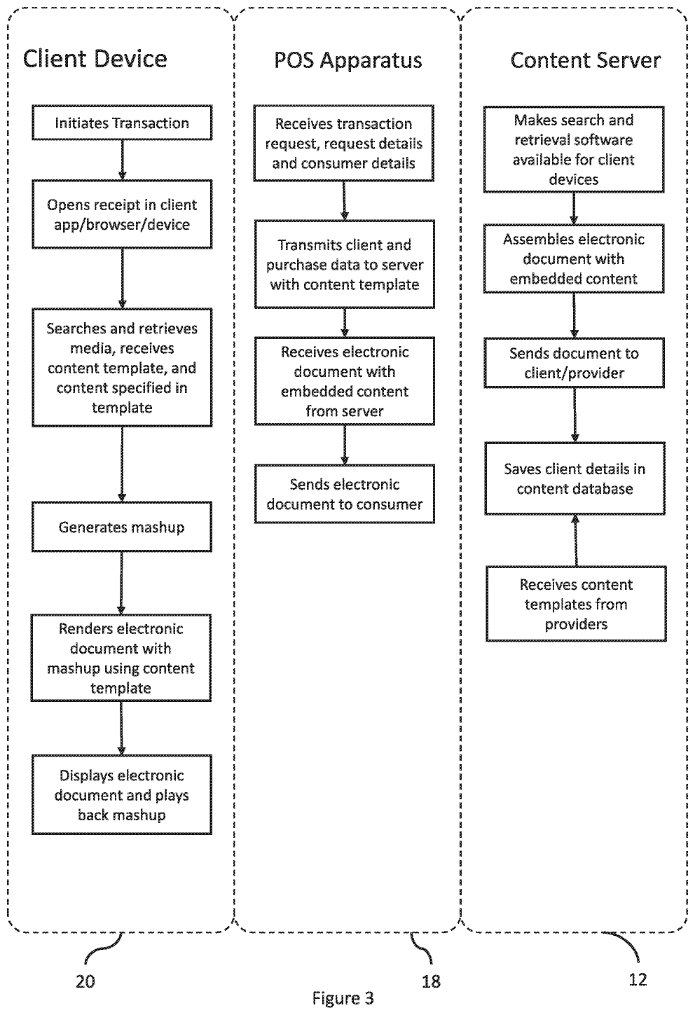

FIG. 3 is a functional block diagram indicating the functionality of the various components of the system 10. The purpose of FIG. 3 is to show the possible functions of the various components. Thus, some of these functions may be duplicated to indicate variations envisaged by the inventor(s).

Each device 20 is configured to permit a user or client to initiate a transaction with a provider. The device 20 is configured so that the device 20 can open an electronic document, such as a receipt, transmitted to it from the apparatus 18. The device 20 is further configured so that it can receive content from the content server 12 and/or the apparatus 18, can embed the content into the electronic document and can display the electronic document and the content to the client. Thus, the device 20 is configured so that the electronic document is compiled in a real-time manner to form, for example, a receipt incorporating video. As set out above, the device 20 is configured to execute search and retrieval software to retrieve media from various sources to use in the content template to generate a mashup.

The apparatus 18 is configured to receive a transaction request from the electronic device 20. The apparatus 18 is also configured to receive details of the transaction together with details relating to the client.

The apparatus 18 is configured so that the apparatus 18 can transmit the details of the transaction request and the client to the content server 12. The apparatus 18 is also configured to transmit a content template, described in further detail below, to the content server 12. In various embodiments, the apparatus 18 is configured to transmit the content template to the client device 20.

The apparatus 18 can be configured to receive the electronic document with the embedded content from the server 12 and to forward the electronic document to the device 20.

The content server 12 is configured to carry out a search and retrieval process to find and retrieve content based on, inter alia, the details of the subject of the transaction request and the client. The search and retrieval process is carried out through various data sources, such as the device 20, websites available through the Internet, and data made available by the provider. The content server 12 can be configured to execute search and retrieval software in order to carry out the search and retrieval process. However, in various embodiments, the device 20 is configured to execute the search and retrieval software to retrieve media for the content template.

The server 12 can be configured to send or transmit the search and retrieval software to the device 20. The server 12 is also configured to store details relating to the client, the transaction and the electronic document in the content database 16.

In various embodiments, the server 12 is configured to assemble the electronic document by embedding the content into the electronic document.

The server 12 is configured to receive content templates, described below, from providers.

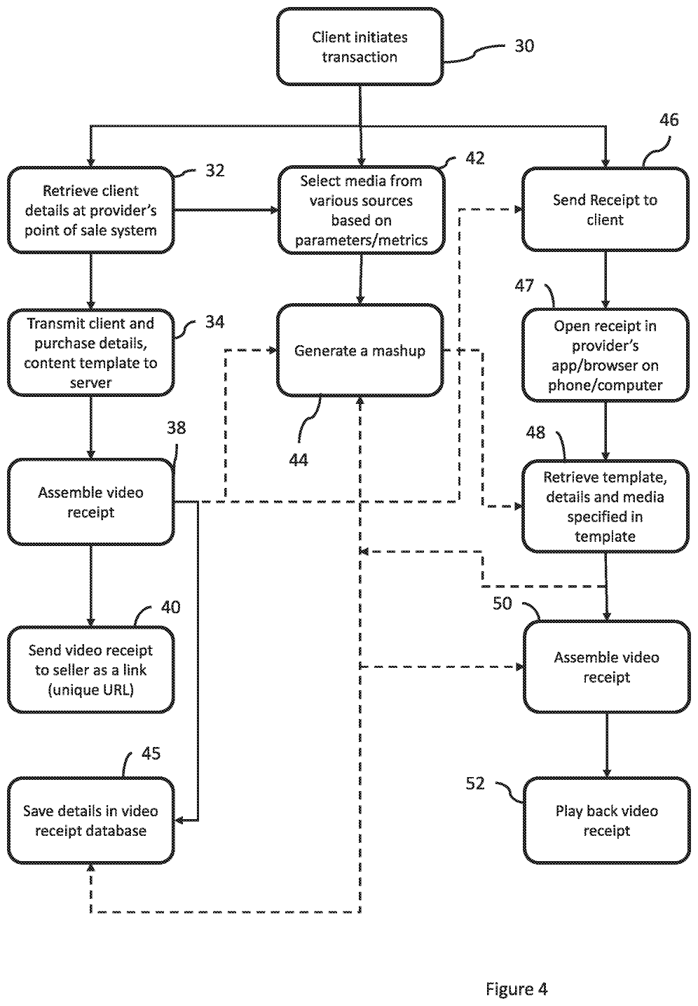

FIG. 4 is a flow diagram illustrating methods for generating electronic documents with embedded content using the system 10.

At 30, a client initiates a transaction request using the electronic device 20. The apparatus 18 receives the request together with details of the client at 32. The nature of the transaction request can vary depending on the required application. For example, the transaction request can involve the purchase of goods or services, the booking of a service, such as entertainment, or any number of other forms of transactions involving a client and a provider.

At 32, the apparatus 18 receives details relating to the transaction request. These can include the identification of the client, various details relating to the client, and the subject matter of the transaction. The apparatus 18 can include a booking or ticketing server that can retrieve the details of the client.

At 34, the apparatus 18 transmits or communicates the retrieved details to the content server 12. These details include details of the client and the details of the transaction, such as details of a purchase. At this step, the apparatus 18 can also transmit a content template to the server 12. The content template can be pre- compiled by the provider or seller or merchant. For example, the content template can be pre-compiled to correspond with the subject matter of the transaction and/or a profile of the client and/or the provider. Also, the content template can be a script file that details content placeholders and animation required to create the content to be embedded in the electronic document. The placeholders can be for content such as video, images, text, audio, etc. Thus, the content can be dynamic such that the content template is a video template. Inside the template, the different media content are assigned tags based on the media type (text, image, video, etc.) and/or the context (name, product, price, etc.). At runtime, the media can be identified and substituted according to the details of the transaction. The substitution may occur on the server or the playback device. The substitution can be explicitly set, e.g. the customer's name, or determined using AI/algorithm, for example a video based on the products purchased.

The content server 12 assembles the electronic document, such as a video receipt, at 38, by embedding content into the electronic document. The content can be embedded according to the content template or video template transmitted to the server 12 by the apparatus 18.

The server 12 sends or transmits the electronic document, incorporating the embedded content, to the apparatus 18, at 40, for forwarding to the device 20 by the apparatus 18. In that case, the server 12 generates a link in the form of a unique URL that is sent to the apparatus 18. Instead, the server 12 can send the electronic document directly to the device 20.

The electronic document or video receipt can be sent to the device 20 via email, SMS, MMS, instant messaging, push notification or in any number of other ways.

At 45, the server 12 saves details from the video receipt in the content database 16. Thus, the content database 16 can be accessed at a later stage for the generation of further electronic documents with embedded content.

In various embodiments, the client device 20, at 42, selects and retrieves content or media from various sources based on various parameters and metrics related to the client. These can include, but are not limited to, content stored on the device 20, preferences recorded by the device 20, purchase history, location, time, time spent on various websites and other parameters that would usually be used for online targeted marketing. To achieve this, the client device 20 can be programmed with suitable information retrieval software that can include an AI module or algorithm that is configured so that, when executed, the client device 20 can carry out the necessary search and retrieval process. The server 12 is configured to transmit the search and retrieval software to the client device 20. It will be appreciated that the AI module may reside elsewhere, as will be described in further detail below.

At 44, the client device 20 generates or compiles a mashup using the retrieved content. At that step, the server 12 could also access the content database 16 and transmit content to the client device 20 to use in compiling the mashup.

Thus, the electronic document, without the dynamic content, can be sent to the device 20, by the apparatus 18 or the server 12, at 46. The document is opened, at 47, by the device 20, in a software product of the provider that is downloaded onto the device 20.

At 48, the device 20 retrieves the content template from the server 12 or the apparatus 18 and the content, in the form of the mashup and other content specified by the content template from the database 16. In various embodiments, the device 20 retrieves the content template from the server 12 or the apparatus 18 and uses the retrieved media to generate the mashup, at 44, using the content template.

The device 20 assembles or renders the electronic document with the embedded content, in the form of a video receipt, at 50 and plays back the video receipt at 52. Thus, the video receipt is assembled in real-time on the device 20.

This process is client-friendly since the client is engaged while the electronic document and the embedded content are displayed. For example, and as can be seen below with reference to the sequence described, the user or client can view various aspects of the electronic document as it is compiled and displayed on the device 20. In an application in which the entire compiled electronic document was to be downloaded, the delay could be frustrating. In certain cases, the delay could result in the client only remaining in communication with the server 12 for a curtailed period.

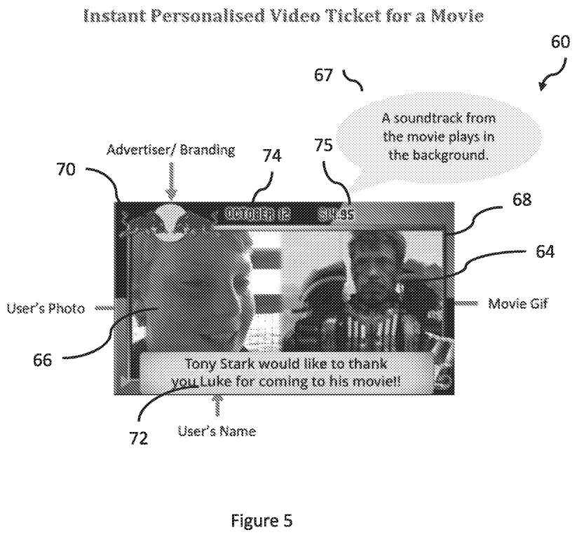

In FIG. 5 there is shown a mashup 60 that has been generated using the system 10 and the method described above. The mashup 60 serves as an entrance ticket for a movie. The mashup 60 is generated as described above. In this case, the device 20 has selected a movie GIF 64, an image 66 of the client and a soundtrack, indicated at 67, from the movie to generate the mashup 60. Those items of media have been selected during the execution of the search and retrieval software described above. Here, the video template could include a frame 68 and a logo 70 for advertising. The video template could incorporate content placeholders so that the device 20 can locate the GIF 64 and the image 66 in the appropriate positions. The content placeholders can be identified using specific tags inserted in the template, or by their content type e.g. video, GIF, etc. The decision on which placeholders will be replaced, and the media/text they are replaced with, can be determined on the server and/or the playback device.

The mashup 60 includes a text block with a field 72 which is populated by a first name of the client. The mashup 60 also includes a text field 74 for a date associated with the movie and a text field 75 for a price paid for the ticket.

Thus, when the mashup 60 is rendered on the device 20, the mashup 60 can serve as an entrance ticket and as a stimulating display for the client, encouraging the client to spend some time with the display open and both viewing and listening to the mashup 62.

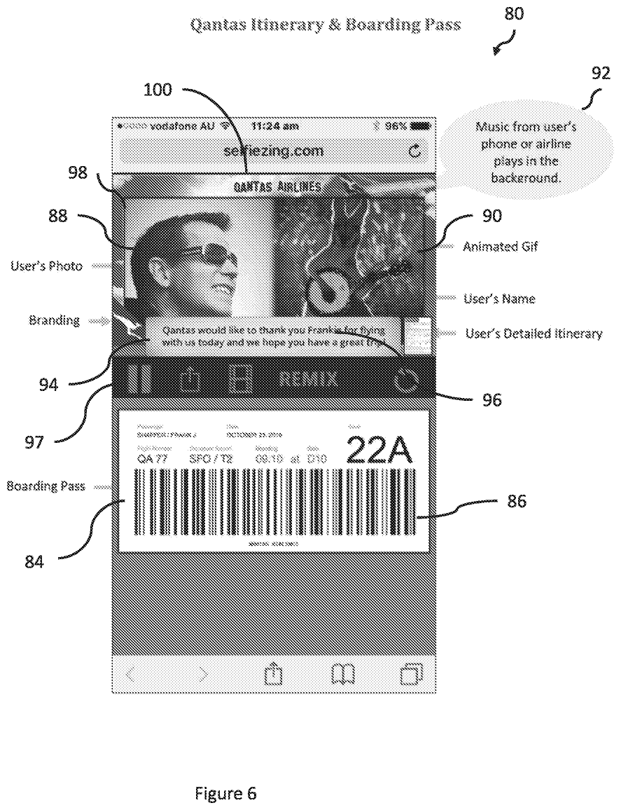

In FIG. 6, there is shown an electronic document 80 that has been generated using the system 10 and the method described above. The electronic document 80 includes a mashup 82 that is generated as described above and embedded into the document 80, also as described above. In this case, the document 80 includes a boarding pass 84. The boarding pass 84 contains a barcode 86 that can be scanned by a boarding official. It will be appreciated that barcode 86 may exist in other scannable forms, for example only, a QR code.

In this embodiment, the mashup 82 includes an image 88 of a user combined with an animated GIF 90. The mashup 82 also includes a music file indicated at 92.

The electronic document 80 incorporates a video template 98 that is supplied by the provider, via the apparatus 18. The video template 98 includes branding 100 associated with the provider. The video template 98 incorporates content placeholders for the components of the mashup 82.

The mashup 82 includes a text block 94 that includes a block of text with a field 96 in which a first name of the user is displayed. The mashup 82 further includes a control bar 97 to allow a client to control playback of the music file 92 using a touch screen of the device 20.

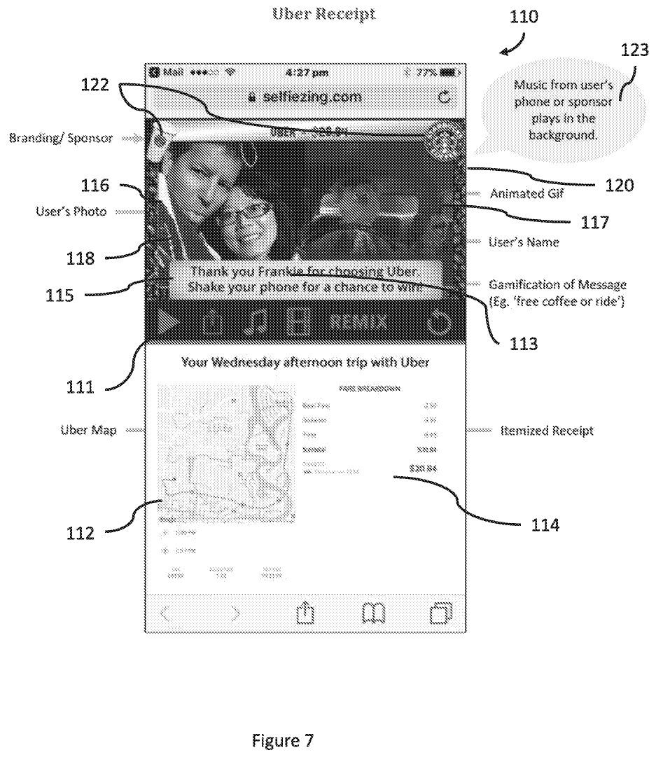

In FIG. 7, there is shown an electronic document 110. In this case, the document 110 is a receipt generated by a provider that supplies transport services. The electronic document 110 is generated by the device 20 to display a map 112 of the route taken by the client together with receipt details indicated at 114.

The electronic document 110 includes a mashup 116. The mashup 116 includes an image 118 of a client combined with an animated GIF 117. The mashup 116 also includes a music file, indicated at 123, for playback when the electronic document 110 is opened. The mashup 116 further includes a control bar 111 to allow the client to control playback of the music file 123.

The mashup 116 also includes a text block 115 that includes a block of text with a field 113 in which a first name of the client is displayed. The electronic document 110 includes a video template 120 that is supplied by the provider, via the apparatus 18. The video template 120 includes branding 122 associated with the provider.

In this embodiment, the electronic device 20 is in the form of a mobile device, of the type that can generate a signal when shaken. In this case, the electronic device 20 is configured so that, when the device 20 is shaken, the electronic device 20 executes a game application. The game application can take various forms. For example, the game application can be configured so that, when executed, a game of chance can be entered into by the client.

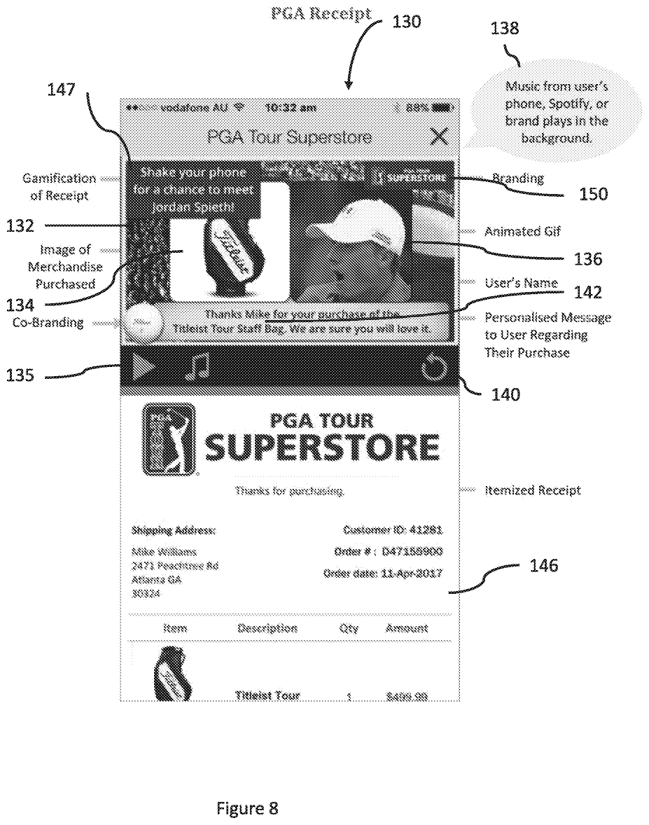

In FIG. 8, there is shown an electronic document 130. The electronic document 130 is a receipt generated by the device 20, the receipt being associated with goods or merchandise.

The electronic document 130 includes a mashup 132. The mashup 132 includes an image 134 of the merchandise purchased by the client. The mashup 132 also includes a GIF 136. The mashup 132 also includes a music file indicated at 138. In addition, the mashup 132 includes a text block 140 with a field 142 in which a first name of the user is displayed. The mashup 132 includes a control bar 135 to allow a client to control playback of the music file 138.

The electronic document 130 also displays text at 147 inviting the client to shake the mobile device 20 so that the mobile device 20 and the server 12 can execute a game.

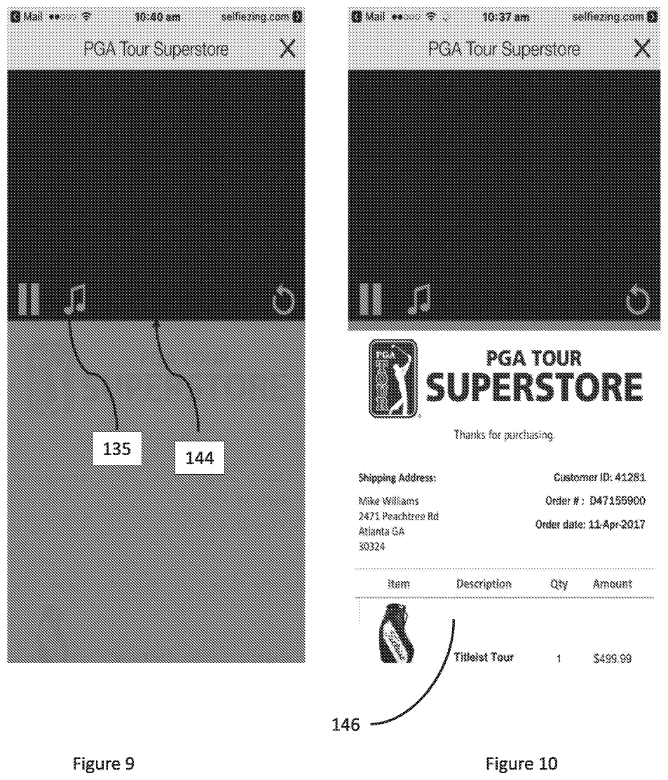

FIGS. 9 to 15 show steps in the compilation or assembly of the electronic document 130 in FIG. 8.

In FIG. 9, the device 20 initiates the assembly by displaying the control bar 135 and an area or zone 144 for images and video.

In FIG. 10, the device 20 displays the receipt details at 146.

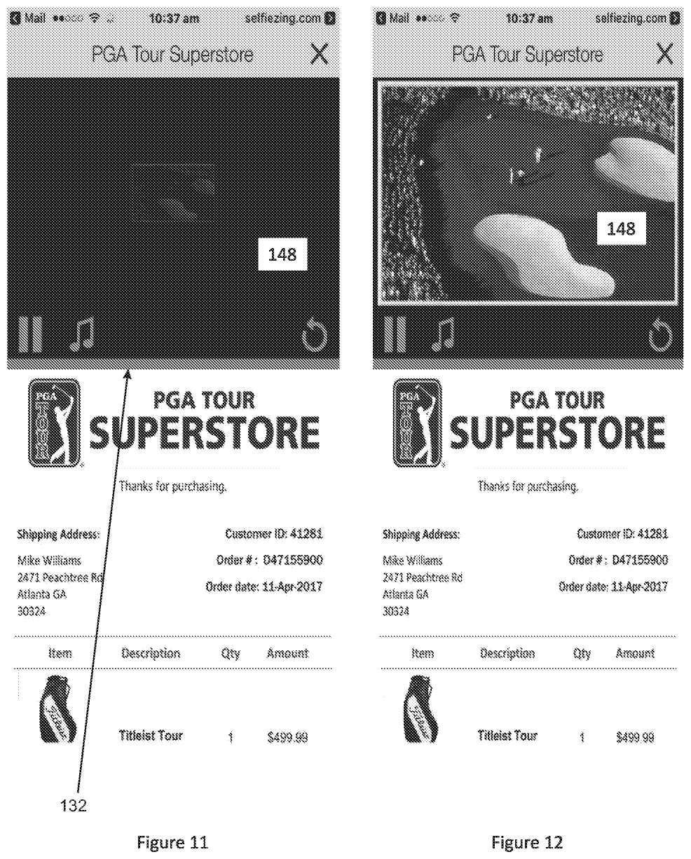

In FIG. 11, a background image 148 which is part of the mashup 132 begins to render in the zone 144.

In FIG. 12, the background image 148 is fully rendered.

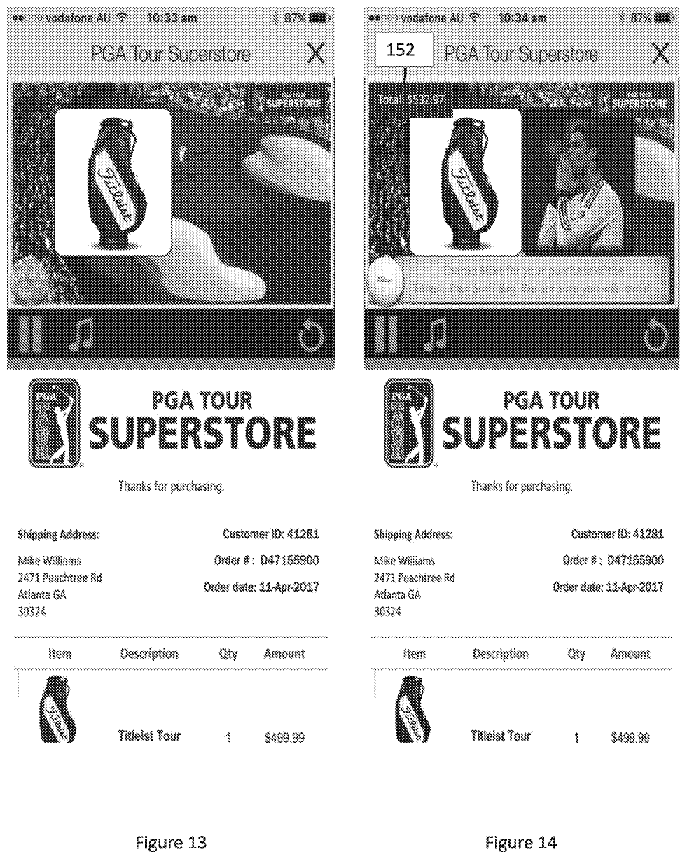

In FIG. 13, the image 134 is overlaid on the image 148. Also, a logo 150 of the provider is displayed on the background image 148.

In FIG. 14, a total price paid by the client is displayed on the background image 148 at 152. Furthermore, the text block 140 begins to render.

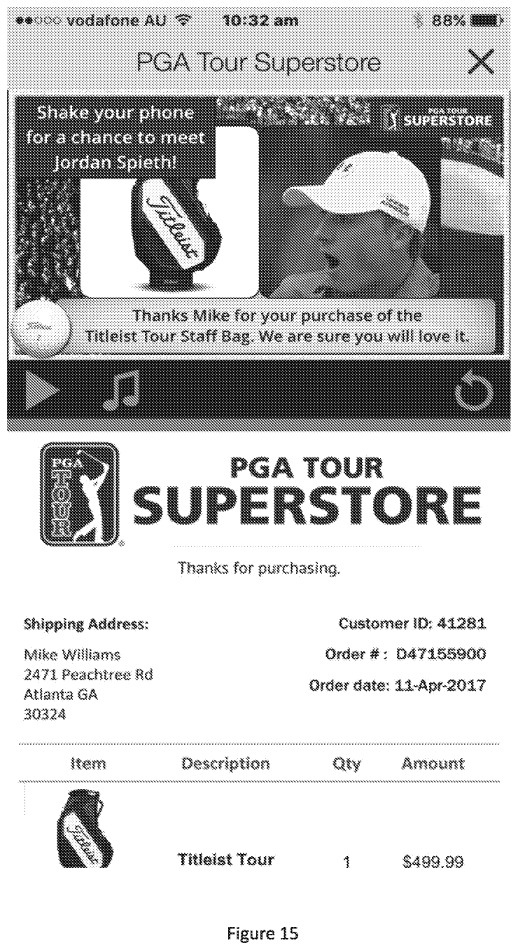

In FIG. 15, the document 130, as fully rendered, is shown.

In online marketing, a critical measurement is the amount of time a client spends engaged with a portal of a provider. The embodiments described above provide a useful mechanism to engage a client, when the client accesses an electronic document reflecting a transaction. It will be appreciated that, in many cases, the client is required to access the document to gain access to merchandise or services. The electronic documents described above provide an incentive for the client to spend more time than would usually be the case when opening such documents.

In the case of receipts, it would not be usual for a client to spend any length of time viewing the receipt. However, in the embodiments described above, the client would be incentivised to remain engaged with the provider portal while engaging or viewing the mashup.

The various embodiments of the systems and methods described above are configured to combine the benefits of providing a client with an electronic transaction record and engaging the client for a longer period than would be possible by presenting content that is relevant to the client. For example, the systems and methods described above are configured to make use of targeted advertising techniques to generate and provide content that can be presented to the client when the client views otherwise uninteresting material, such as a purchase receipt or a boarding pass. This is an opportunity for the provider to advertise further material while also engaging the attention of the client for longer than is presently the case.

The system and method described herein illustrate the generation of a mashup on a mobile device. This is particularly useful since it facilitates the generation of personalised mashups on mobile devices without excessive server load.

For example, consider an event at which many mobile devices are present. At that event, it may be possible for clients to use their devices to obtain further information regarding the event. Alternatively, the clients may use their devices to obtain tickets or merchandise related to the event. A load on a server would be significant if it were necessary for those devices to connect to the server to download the mashup from the server. Such an arrangement can be costly because of the nature of the server required and the extent of data transfer required from the server.

in certain embodiments, the devices themselves carry out the search and information retrieval process. Not only does this provide personalised content, but it also obviates the need for the server to provide the media required for the mashups. Furthermore, the processing power required for the retrieval and assembly of the mashups is provided by the mobile devices.

The system described above may be configured to incorporate Artificial Intelligence (AI). The client device 20 may be configured to receive the information retrieval software that incorporates the AI. The coding to implement AI in the information retrieval field would be understood by a person of ordinary skill in the art, and for simplicity, is not detailed herein. The information retrieval software or the AI may be configured to prompt the device 20 to retrieve information or media based on one or more of client browsing history, client purchase history, time spent by client on various sites and social networking platforms, media stored on the client device, details of products or services purchased by the client, pages or topics followed on social media platforms, and other parameters that would be used by existing information retrieval software products to determine the characteristics or marketing profile of the client.

The media or information retrieved can include video files, image files, sound files, text files, scent files for rendering with suitable apparatus on the client device 20, and other media. The process of retrieving the media can be based on web-scraping processes, also known as web harvesting or web data extraction.

Thus, the information retrieval software can include one of more multi- media bots or web crawlers that are configured to systematically browse the Internet based on a ranking or weight to retrieve media or information relating to the client so that the content template can generate the display incorporating the media according to the content template.

Some search platforms, for example search platforms supplied by Google Inc., make use of software modules that are available for use by third party users. Also available are software modules that are specific to certain platforms, such as those owned and operated by Facebook, Inc., Spotify AB, Twitter Inc. The information retrieval software can be configured to select, for example, by providing a weighting or ranking to each of these platforms, any platform, as part of an automated selection process in which the retrieval software selects which of the platforms require more attention than others. This can be based on the extent of use that a client has of one platform over another.

For example, the retrieval software can elect to execute a module that is provided by Facebook, Inc. if it has given a certain ranking or weight to the Facebook (trade mark) platform. As a result, media from Facebook can be retrieved preferentially to media from other sources. As a result, the retrieval software is configured to execute retrieval processes that are associated with platforms that are used by the client. The resultant mashup is more likely to retain the client's attention than if the retrieval process was only limited to the media preferred by the client. This also provides more focus and depth. For example, if the retrieval software determines that a client is a follower of an artist on Twitter (trade mark), then the retrieval software is able to retrieve the media from the Twitter feed and related sources, rather than from a random search of the Internet.

The various platforms described above may be configured to only make their own modules available to third parties. On the other hand, the information retrieval software can select which modules to use to best suit the client or the determined profile of the client that has been generated as a result of the use of the client device 20. In other words, the information retrieval software can be configured to aggregate the modules or retrieval software products of the various platforms described above to generate a hybrid of search functionality.

The AI mentioned above can be configured so that the retrieval software can cause the device 20 to carry out a machine learning process as it executes the various retrieval processes. Thus, the retrieval software can continuously configure itself to identify habits of the user of the device.

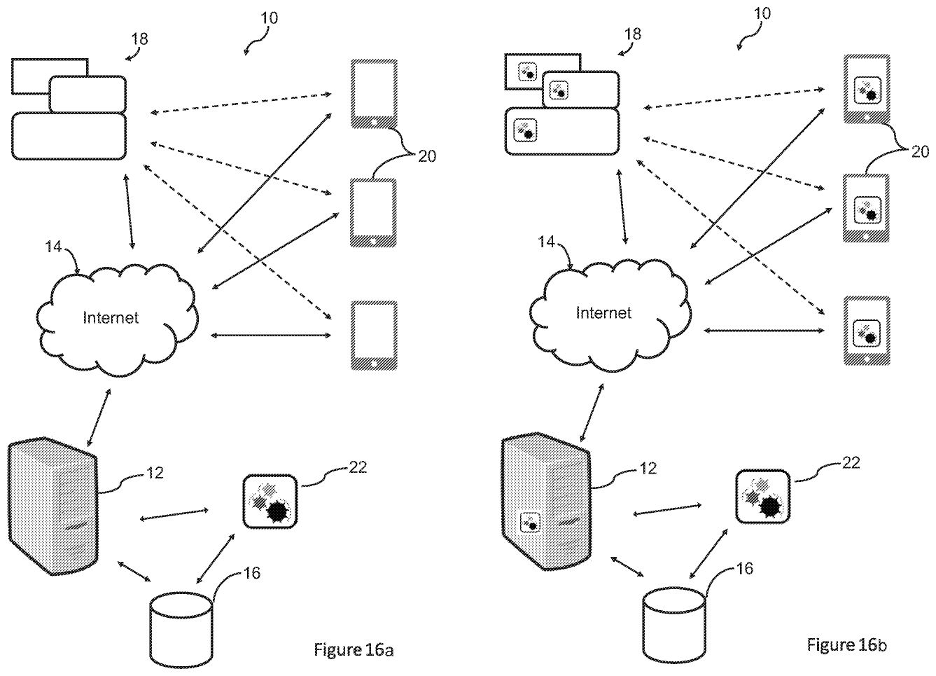

It will be appreciated that the systems and methods described herein may be modified without departing from the spirit and scope of the present disclosure. For example only, FIG. 16a shows a system 10 that is similar to system 10 described above, except that system 10 in FIG. 16a includes an orchestration module or server 22 formed as part of content server 12 and/or content database 16. Orchestration module 22 utilizes one or more algorithms to drive AI functionality, such as already described above. Example algorithms may include, but are not limited to, self-learning algorithms and AI algorithms which progressively learn from data resident on, or acquired by the system, and build system efficiencies in a manner best suited to a particular user. A self-organizing algorithm may be included in orchestration module 22 if desired. The self-organizing algorithm is an automated design/process to make the configuration and management of internal system processes more simple and quick. A self-correcting algorithm may be included in orchestration module 22 if desired. Other algorithms that may be included utilize geo-location and/or geo-fencing for targeted marketing when a user enters a virtual boundary. It will be appreciated that the number and combination of different algorithms may be varied as desired in order to achieve a desired outcome.

FIG. 16b shows a system 10 that is similar to system 10 shown and described above in relation to FIG. 16a, except that orchestration module 22 is resident on multiple system components in a distributed system architecture. For example, one or more of mobile devices 20, POS apparatus 18, and/or content server 12 may include a portion or the whole of orchestration module 22 to drive the system with AI functionality. As shown in FIG. 16b, a main or primary orchestration module may be appended to one or both of content server 12 and/or content database 16 as desired, while still controlling elements or sub-portions of the orchestration module throughout the system.

Each architecture (central or distributed orchestration module) provides one or more advantages, and may be appropriate depending upon the intended use. For example, if an intended use is time-sensitive, then location of orchestration module 22 closer to the edge (e.g., client device 20) would benefit the user. If correlation from multiple system components is desired, an efficient system architecture may be designed so that the orchestration module is centrally located, for example, as shown in FIG. 16a. A centralized location would allow an algorithm access across multiple servers to gain access to a variety of datapoints, and a way to correlate the data for a specific use. The correlation may factor in historic patterns to optimize an outcome of a self-learning algorithm. In contrast, distributed algorithms in this context would have limited access to data relying on stored devices, such as client device 20, thus potentially hampering development of a self-learning algorithm utilizing data across multiple devices.

From the above, it may be seen that the algorithm location (e.g., local, distributed and/or central) may be considered in view of optimizing the user experience.

Examples of AI functionality utilizing one or more of the above-described algorithms are further described in examples below, and may be configured for use with a centralized orchestration module or a de-centralized, distributed orchestration module.

The following is an example involving a centralized use, taking into account the need for correlation for a specific condition that when detected can trigger a specific process that sends the client device a data set including multiple media types (URL, video, etc.). The data to be sent will be customized based on the detected condition for a client device. For example, in the medical field, it may be desirable to send a document, video, prescription, etc., based on a specific condition or combinations of conditions. The sources the doctor may want the patient to view generally are not viewed because the patient instead reads blogs and non-medical opinions that lead to more issues like multiple visits, phone calls, patient stress, etc. Sending only doctor-certified documentation in a digital payment receipt can reduce the amount of time spent at a front desk printing various documents. Further, the patient will now have extended care through doctor-certified documentation, video and webpages that keep in line with the doctor's prognosis.

As a specific example, an elderly person goes to a cardiologist and at checkout, the system such as described above, using a video receipt, detects specific conditions: (a) elderly man aged over 75, (b) Long QT syndrome diagnoses, and (c) hereditary condition. Based on the identified conditions, the system generates a specific “receipt” with customized, patient-specific documentation, videos and/or webpages based on the various detected conditions. As time progresses, reminder “receipts” could be sent with specific material and appointment reminders that the elderly patient can click on to save reminders to calendar or other action. The same condition can be existing in a younger patient, but the conditions are different and generate a different output. Further, the system can determine through appointments the habits of any patient and adjust reminders accordingly using an appropriately configured learning algorithm.

In another example, this time involving a de-centralized, distributed use, control logic is contained within the client device. An AI algorithm accesses specific data/information contained on the client device that is not on a content server or other centralized location. A background condition for this use case is that there is access to data that may not be accessible today, but may be needed at some future date. For example, perhaps an agreement with a specific vendor is required to gain access to such data, but today the agreement is not in place. An AI algorithm may be configured to use the location services on the client device and access calendar information.

As a particular example, a client device user has a traveling day and will be leaving on a plane at a specific time. The user stores their itinerary on their client device calendar. The user generally desires to arrive at the airport with just enough time to make their flight. The system determines that user is enroute to the airport based on GPS (location services) and calendar itinerary that indicates address of the airport. An orchestration module resident on the client device, and optionally embedded in the template, determines that the time to flight exceeds a predetermined time limit based on the user's location. When the time limit exceeds a pre-determined minimum arrival time (e.g., 50 minutes to plane departure), the user is classified as running late and the system sends gate information, airport parking information and a reminder that the flight is 50 minutes from departure. A pattern recognition algorithm may determine that such behavior is consistent for the particular user. The orchestration module can then modify the timing for the reminder so that an earlier reminder is provided to the user, e.g., earlier than 50 minutes. The algorithm may be configured to factor in environmental factors as well as user behavior patterns. For example, inclement weather may be factored in by the orchestration module via a live weather data feed. Alternatively, or additionally, flight delays may be included by the orchestration module in modifying the timing of the reminder.

In another aspect, the system and method may be configured for use in the recruitment industry. Present methods use either a video or text-based resume in isolation. Both of these formats by themselves have shortcomings that inevitably require the addition of the other half during the recruitment process. A template such as described above may be configured to include both the text resume along with an applicant video contextually inside the frame to give a best of both worlds option for the viewer to focus on. In addition, the recipient company/viewer has a further “call to action bar” (e.g., call me, email me, not interested) that when selected immediately notifies the recruiter of their choice. This combination of media inside a candidate's profile will substantially reduce costs in the recruitment process by shortening placement times by an estimated 30-50%.

This flexible multimedia format also lends itself to text-based AI carried out separately from video-based AI, but that can then easily be combined back into the platform for further data analysis. For example, this process could involve using AI to extract out and highlight relevant textual components of a candidate's work history along with a link to their full resume. Blending this in real-time with video AI that analyses a candidate's body language and voice intonations dramatically enhances the filtering process compared to one type of AI applied in isolation.

Playback of such a hybrid video format can also take on a dynamic aspect that traditional video files cannot. In their current format, video files are very rigid and would require extensive editing to change, for example from a horizontal video to a vertical video. A dynamic multimedia format, however, automatically reshuffles the various components from one shape to another to maximize screen space so that playback on horizontal desktops and vertical phones are quickly accommodated. This multimedia reformatting also easily lends itself to being augmented with AI across the image, text, and video spectrum simultaneously rather than one form of media at a time.

A sample use case could involve candidates being asked to fill out a questionnaire or submit a resume on their phone (e.g. via a cloud-based platform) along with a 30-second video of themselves (e.g., via web-based filming, or uploaded). Upon making these two submissions, candidates could then “shake their phone” (or any other trigger command) to instantly create a blending of all the multimedia content together into a choreographed profile of themselves.

It will be appreciated that the system may be configured so that in a template residing on, or being delivered to a client device 20 may identify a client device type (e.g., computer, phone, tablet, etc.), and re-size according to the display size area of the client device. A display template orientation may be fixed or dynamic. For example, if a video is delivered to a phone, an initial assumption is that the orientation will be in a vertical format, and the orientation fixed so that if the user tilts their phone, the displayed video will remain presented in a vertical format in the display. Alternatively, the template may be configured to be dynamic so that the orientation may switch between a horizontal or vertical orientation, depending upon the orientation and/or type of the client device. An algorithm may be incorporated in the system or client device so that the user's preferences are learned over a period of time, and certain orientations will fix a vertical or horizontal format depending on user behavior and interaction with the client device, and/or content being delivered to, or displayed on the client device.

The appended claims are to be considered as incorporated into the above description.

Throughout the specification, including the claims, where the context permits, the term “comprising” and variants thereof such as “comprise” or “comprises” are to be interpreted as including the stated integer or integers without necessarily excluding any other integers.

It is to be understood that the terminology employed above is for the purpose of description and should not be regarded as limiting. The described embodiments are intended to be illustrative of the invention, without limiting the scope thereof. The invention is capable of being practised with various modifications and additions as will readily occur to those skilled in the art.

1. A method of generating a display on a client device, the method comprising the steps of:
receiving client information from the client device; transmitting content template to the client device;
executing information retrieval software in the client device so that the client device finds and retrieves media relating to the client information; and
displaying a mashup on the client device using the retrieved media and according to the content template.

2. The method as claimed in claim 1, wherein the steps of receiving the information from the client device and transmitting the content template are carried out over a wireless network.

3. The method as claimed in claim 1, wherein the step of executing the information retrieval software in the client device is carried out so that the retrieved media includes media retrieved from the client device.

4. The method as claimed in claim 1, wherein the step of executing the information retrieval software in the client device is carried out so that the retrieved media includes media retrieved from various sources on the Internet.

5. The method as claimed in claim 1, wherein the step of executing the information retrieval software in the client device is carried out so that the retrieved media includes media retrieved from the provider device.

6. The method as claimed in claim 1, which includes the step of displaying the mashup on the client device together with provider information relating to the client information.

7. The method as claimed in claim 1, which includes the step of transmitting the information retrieval software from the provider device to the client device.

8. A system for generating a visual display on a client device, the system comprising:
the client device that stores information retrieval software and that is configured to execute the information retrieval software upon receipt of information; and
the client device that is configured to receive a content template and to generate and display a mashup using media retrieved as a result of the execution of the information retrieval software.

9. A method of generating an electronic document comprises the steps of:
receiving, in a server, a transaction request from a client device; receiving, in the server, transaction confirmation data from a provider;
generating, in the server, an electronic document that displays details of the transaction request and the transaction confirmation for rendering on the client device;
transmitting the electronic document to the client device together with a content template; and
embedding the content into the electronic document in the client device according to the content template.

10. The method as claimed in claim 9, wherein the step of generating the content includes the step of executing information retrieval software in the client device to retrieve content related to at least one of the client and the provider and creating a mashup with the retrieved content.

11. The method as claimed in claim 10, wherein the content is retrieved from at least one of the client device, websites, and a provider device.

12. The method as claimed in claim 11, which includes the step of executing a search algorithm in the client device to search for, and identify, content related to the client.

13. The method as claimed in claim 9, which includes the step of receiving a content template and embedding the content into the electronic document according to the content template.

14. (canceled)
